(19) United States
(12) Patent Application Publication
(10) Pub. No.: US 2024/0369147 A1
(43) Pub. Date: Nov. 7, 2024

(54) PRESSURE EQUALIZATION DEVICE FOR A HOUSING

(71) Applicant: Illinois Tool Works Inc., Glenview, IL (US)

(72) Inventors: Ilaria GIACOMELLI, Hone (IT); Fulvio Pacifico YON, Donnas (IT); Andrea Giovanni COCCOZ, Ivrea (IT)

(21) Appl. No.: 18/651,015

(22) Filed: Apr. 30, 2024

(30) Foreign Application Priority Data
May 5, 2023 (EP) 23171860.2
Apr. 22, 2024 (FR) 2404140

(51) Int. Cl. F16K 17/16; H01M 50/342

(52) U.S. Cl. CPC F16K 17/16; H01M 50/3425

(57) ABSTRACT

The disclosure relates to a pressure equalization device for a battery housing, the device comprising a membrane for equalizing, in use, the pressure inside the housing with the ambient pressure outside the housing, in which the membrane is configured to detach at least partially, at a predetermined temperature and/or at a predetermined pressure differential between the inside and the outside of the housing, to prevent overheating and/or overpressure inside the housing.

### TECHNICAL FIELD

This disclosure relates to the field of pressure equalization devices making it possible to compensate for the variation in pressure inside a housing and to systematically release the pressure in the event of overpressure (for example, by means of a degassing device).

### BACKGROUND

The use of a pressure compensation element for accumulators is known from patent EP3385584, filed by Freudenberg. More precisely, this element combines the function of pressure compensation in normal operation but also that of reducing the overpressure during an emergency degassing.

### BRIEF SUMMARY

Aspects of this disclosure relate to a pressure equalization device for a housing, for example a battery housing. The device can be configured to equalize the pressure in the housing of devices other than batteries.

The device can comprise a membrane for equalizing, in use, the pressure inside the housing with the ambient pressure outside the housing.

The membrane can be configured to detach at least partially at a predetermined temperature to prevent overheating inside the housing.

The inventors found that configuring the membrane so that it detaches in case of overheating and/or overpressure is a simple and reliable way of preventing such situations.

The membrane can be configured to detach at least partially at a predetermined pressure differential between the inside and the outside of the housing to prevent overpressure inside the housing.

The membrane can be configured to detach at least partially, at a predetermined temperature and/or at a predetermined pressure differential between the inside and the outside of the housing, to prevent overheating and/or overpressure inside the housing.

Aspects of this disclosure also relate to a pressure equalization device for a battery housing, the device comprising a membrane for equalizing, in use, the pressure inside the housing with the ambient pressure outside the housing, in which the membrane is configured to detach at least partially at a predetermined temperature and/or at a predetermined pressure differential between the inside and the outside of the housing, to prevent overheating and/or overpressure inside the housing.

The membrane can be gas-permeable. The membrane can be liquid-impermeable. The membrane can allow air to pass through it to equalize the pressure inside the housing with the ambient pressure outside the housing.

More specifically, the membrane can be gas-permeable and liquid-impermeable to allow air to pass through it to equalize the pressure inside the housing with the ambient pressure outside the housing.

The device can comprise a cage. The cage can define a fluid passage. The membrane can be attached to the cage, for example by a frangible connector. The membrane can cover the fluid passage.

The frangible connector can be configured to break, for example at a predetermined temperature. In addition or alternatively, the frangible connector can be configured to break at a predetermined pressure differential between the inside and the outside of the housing.

The frangible connector can be configured to break to expose the fluid passage, for example to prevent overheating. In addition or alternatively, the frangible connector can be configured to break to expose the fluid passage to prevent overpressure inside the housing.

More specifically, the device can comprise a cage defining a fluid passage with the membrane attached to the cage by a frangible connector and covering the fluid passage, in which the frangible connector is configured to break, at a predetermined temperature and/or at a predetermined pressure differential between the inside and the outside of the housing to expose the fluid passage to prevent overheating and/or overpressure inside the housing.

The frangible connector can comprise a hot-melt material. The hot-melt material can comprise a hot-melt adhesive or a thermoplastic adhesive, for example ethylene vinyl acetate.

In some examples, the only bond between the membrane and the cage is provided by the frangible connector.

In some examples, one part of the membrane is attached to the cage by the frangible connector while another part of the membrane is permanently attached to the cage.

The cage can comprise a tubular part. The tubular part can define the fluid passage. The membrane can be attached to the tubular part, for example around one end of the tubular part, to cover the fluid passage.

More specifically, the cage can comprise a tubular part defining the fluid passage and the membrane is attached around one end of the tubular part to cover the fluid passage.

The device can comprise a lid. The lid can cover the cage.

More specifically, the device can comprise a lid covering the cage.

The lid can be loosely fitted to a tubular wall of the cage, so that air can pass between them.

One or more passages can also be defined between the lid and the tubular wall, which can allow air to pass between the two.

The cage can comprise a lip. The cage can comprise a gasket. The gasket can be spaced apart from the lip. The lip and/or the gasket can be configured to capture, in use, a wall of the housing between them, for example to seal the cage in a hole in the housing.

More specifically, the cage can comprise a lip and a gasket spaced apart from the lip which are configured to capture, in use, a wall of the housing between them to seal the cage in a hole in the housing.

The cage can comprise a bayonet coupling. The bayonet coupling can have at least one flange, for example two or more flanges. The flange or flanges can, for example, each define a part of the cage lip.

More specifically, the cage can comprise a bayonet coupling with two or more flanges each defining a part of the cage lip.

Aspects of this disclosure also relate to a pressure equalization device, for example for a battery housing, the device comprising: a cage defining a fluid passage; and a membrane attached to the cage by a frangible connector and covering the fluid passage; in which the membrane is configured to equalize, in use, the pressure inside the housing with the ambient pressure outside the housing; while the frangible connector is configured to break, at a predetermined temperature and/or at a predetermined pressure differential between the inside and the outside of the housing, to expose the fluid passage to prevent overheating and/or overpressure inside the housing.

To avoid any doubt, all the features described herein also apply to any aspect of the disclosure.

To avoid any ambiguity, the terms “can”, “and/or”, “for example”, and any other similar term used herein must be interpreted as not limiting, such that any feature thus described is not necessarily required to be present.

### BRIEF DESCRIPTION OF THE DRAWINGS

Other features and advantages of the disclosure will become apparent from the following detailed description, which will be understood in reference to the appended drawings, in which:

FIG. 1 illustrates a pressure equalization device for a battery housing according to an example under normal operating conditions, where the membrane enables pressure equalization between the inside and the outside of the battery housing;

FIG. 2 illustrates the device in FIG. 1 in an overheating and/or overpressure situation; and

FIG. 3 illustrates the device shown in FIG. 2 without the top side of the lid.

### DETAILED DESCRIPTION

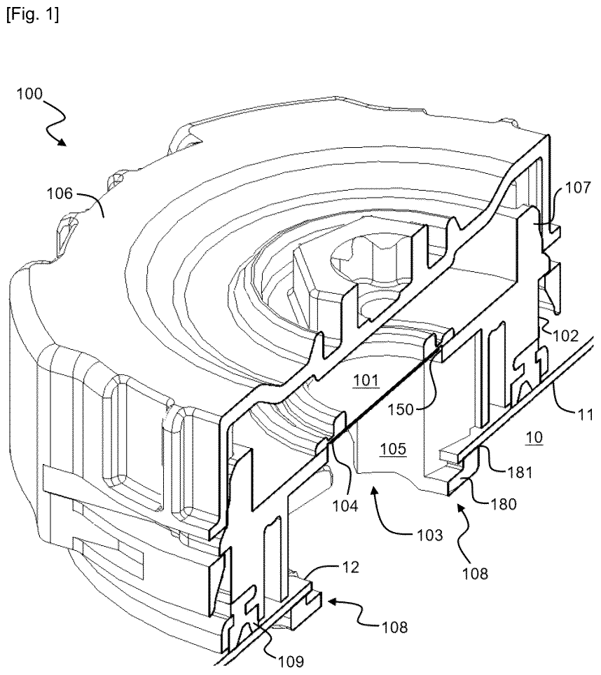

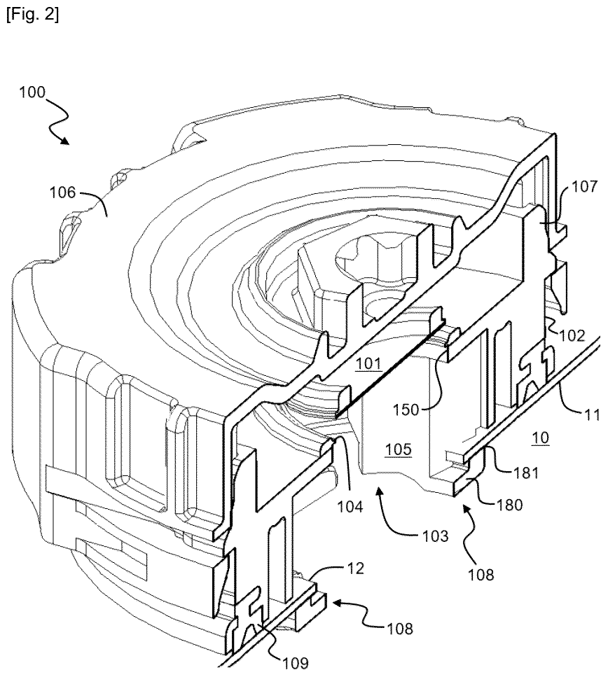

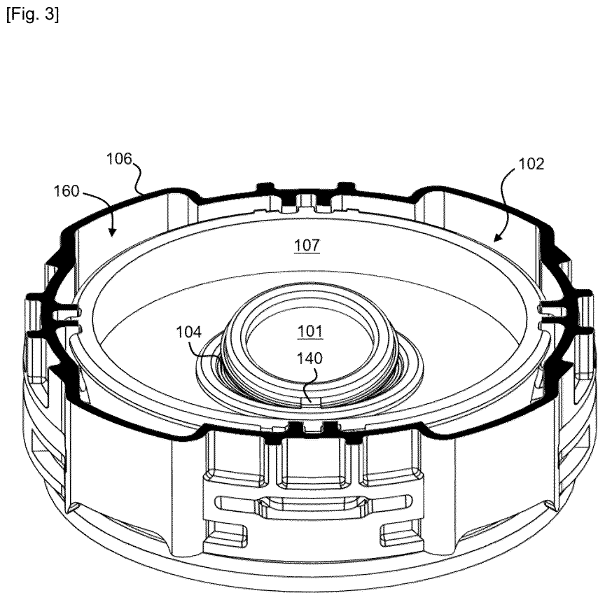

Referring now to FIGS. 1 to 3, a pressure equalization device 100 for a battery housing 10 can be seen. The device 100 comprises a membrane 101 and a cage 102 defining a fluid passage 103. One part of the membrane 101 is attached to the cage 102 by a frangible connector 104 while another part of the membrane 101 is attached to the cage 102 by a permanent connector 140, so that it covers the fluid passage 103. The frangible connector 104 comprises a hot-melt material, for example a hot-melt adhesive (HMA or “hot glue”) in the form of a thermoplastic adhesive such as ethylene vinyl acetate.

In this example, the cage 102 comprises a tubular part 105 defining the fluid passage 103 and the membrane 101 is attached around one end 150 of the tubular part 105 to cover the fluid passage 103. In some examples, the only bond between the membrane 101 and the cage 102 is provided by the frangible connector 104.

The device 100 also comprises a lid 106 covering the cage 102. The lid 106 is loosely fitted to a tubular wall 107 of the cage 102, so that air can pass between them. In particular, four passages 160 are also defined between the lid 106 and the tubular wall 107, which allow air to pass between them.

The cage 102 comprises a bayonet coupling 108 with four flanges 180 and a gasket 109 spaced apart from the flanges 180. The flanges 180 each define a part of a lip 181 of the cage 102 which is configured to cooperate with the gasket 109 to capture a wall 11 of the housing 10 between them to seal the cage 102 in a hole 12 in the housing 10.

When the device 100 is sealed in the hole 12 of the cage 102, air can pass through the membrane 101 to equalize the pressure inside the housing 10 with the ambient pressure outside the housing 10. The membrane 101 is gas-permeable and liquid-impermeable to allow air to pass through.

However, if there is a rapid increase in the heat and/or pressure inside the housing 10, the frangible connector 104 is configured to break at a predetermined temperature and/or at a predetermined pressure differential between the inside and the outside of the housing 10. This exposes the fluid passage 103, to prevent overheating and/or overpressure inside the housing 10.

More specifically, the frangible connector 104 is a weak point that will break before the membrane 101. In this example, the frangible connector 104 is made of a hot-melt material. Therefore, the pressure differential at which the frangible connector 104 breaks will decrease as the temperature to which the frangible connector 104 is exposed increases.

In some examples, the frangible connector 104 can be stronger than the membrane 101 at normal operating temperatures, but weaker than the membrane 101 when the temperature reaches a predetermined limit. In other examples, the frangible connector 104 can be a weak point even under normal operating conditions, since the pressure at which the membrane 101 detaches decreases as the temperature increases.

The person skilled in the art will understand that the embodiments described above can vary in many ways, provided they are consistent with the scope of the claims.

### LIST OF REFERENCE NUMBERS

battery housing
11 housing wall
12 hole in the housing
100 pressure equalization device
101 membrane
102 cage
103 fluid passage
104 frangible connector
140 permanent connector
105 tubular part
150 end of tubular part
106 lid
160 passages
107 tubular wall
108 bayonet coupling
180 flange
181 lip
109 gasket

What is claimed is:

1. A pressure equalization device for a battery housing, the device comprising a membrane for equalizing, in use, the pressure inside the housing with the ambient pressure outside the housing, in which the membrane is configured to detach at least partially at at least one of a predetermined temperature or a predetermined pressure differential between the inside and the outside of the housing, to prevent at least one of overheating or overpressure inside the housing.

2. The pressure equalization device according to claim 1, wherein the membrane is gas-permeable and liquid-impermeable to allow air to pass through to equalize the pressure inside the housing with the ambient pressure outside the housing.

3. The pressure equalization device according to claim 1, further comprising a cage defining a fluid passage and the membrane is attached to the cage by a frangible connector and covering the fluid passage, in which the frangible connector is configured to break, at at least one of the predetermined temperature or the predetermined pressure differential between the inside and the outside of the housing, to expose the fluid passage to prevent at least one of overheating and/or overpressure inside the housing.

4. The pressure equalization device according to claim 3, wherein the frangible connector comprises a hot-melt material.

5. The pressure equalization device according to claim 3, wherein the only bond between the membrane and the cage is provided by the frangible connector.

6. The pressure equalization device according to claim 3, wherein one part of the membrane is attached to the cage by the frangible connector, while another part of the membrane is permanently attached to the cage.

7. The pressure equalization device according to claim 3, wherein the cage comprises a tubular part defining the fluid passage and the membrane is attached around one end of the tubular part to cover the fluid passage.

8. The pressure equalization device according to claim 3, further comprising a lid covering the cage.

9. The pressure equalization device according to claim 8, wherein the lid fits loosely to a tubular wall of the cage, so that air can pass between them.

10. The pressure equalization device according to claim 3, wherein the cage comprises a lip and a gasket spaced apart from the lip which are configured to capture, in use, a wall of the housing between them to seal the cage in a hole in the housing.

11. The pressure equalization device according to claim 10, wherein the cage comprises a bayonet coupling with two or more flanges each defining a part of the lip of the cage.
